(19) United States
(12) Patent Application Publication
(10) Pub. No.: US 2026/0009246 A1
(43) Pub. Date: Jan. 8, 2026

(54) STRIPPING DEVICE, STRIPPING METHOD, AND PROGRAM

(71) Applicant: NIPPON TELEGRAPH AND TELEPHONE CORPORATION, Tokyo (JP)

(72) Inventors: Yosuke TAKEUCHI, Tokyo (JP); Wataru ITO, Tokyo (JP)

(73) Assignee: NIPPON TELEGRAPH AND TELEPHONE CORPORATION, Tokyo (JP)

(21) Appl. No.: 18/992,506

(22) PCT Filed: Jul. 15, 2022
(86) PCT No.: PCT/JP2022/027944

§ 371 Date: Jan. 8, 2025

(51) Int. Cl. E04G 23/08; H01M 4/38

(52) U.S. Cl. CPC E04G 23/08; H01M 4/38; H01M 2300/0011; H01M 2300/0085

(57) ABSTRACT

A peeling device (1) includes an electrolyte sheet (11) stuck to a concrete surface, a first electrode (12) connected to the electrolyte sheet (11), a second electrode (13) connected to an exposed reinforcing bar, a potential control unit (14) that applies a voltage to the second electrode (13) by using the first electrode (12) as a reference electrode and performs potential control such that a potential generated in the second electrode (13) falls within a predetermined range, and a current measurement unit (15) that continuously measures a current value of a current flowing from the second electrode (13) to the first electrode (12).

### TECHNICAL FIELD

The present disclosure relates to a peeling device, a peeling method, and a program for assisting with repair of a concrete structure in which a reinforcing bar is embedded.

### BACKGROUND ART

Conventionally, a region requiring repair of a concrete structure in which a reinforcing bar is embedded can be specified by a non-destructive evaluation method such as a natural potential measurement method, but the evaluation result does not go beyond the range of estimation. Therefore, the region requiring repair of the concrete structure in which the reinforcing bar is embedded has been specified by peeling out the concrete to an extent that corrosion of the reinforcing bar cannot be visually checked. Chipping or chipping out is referred to as “small-scale work of a concrete portion”, and work such as cutting concrete, making holes, and shaving is assumed as the main content.

In general, steel material corrosion is not allowed in maintenance of a concrete structure in which a reinforcing bar is embedded. This is because the limit value Slim of a steel material corrosion depth is limited to a small value calculated by the following Expression (1). FIG. 8 is a view for describing a region in which an exposed streak portion is deteriorated, and repair is needed in the related art. In FIG. 8, a fogging c [mm] is the minimum distance from a concrete surface to the reinforcing bar.

The limit value Slim of the steel material corrosion depth=3.81×10⁻⁴×c [mm] (1)

Therefore, when the corrosion of the reinforcing bar and the exposed streak become apparent, the exposed streak portion is repaired, and thus the deterioration progress process after the corrosion of the reinforcing bar is not a target or management. The exposure streak means a state in which the reinforcing bar inside the concrete floats and peels off when the reinforcing bar corrodes and deforms, and thus the reinforcing bar is exposed. Also for an MH (manhole) upper floor slab, the deterioration progress process after the corrosion of the reinforcing bar in the exposed streak portion remains unsolved.

As shown in the picture of FIG. 8, the corrosion of the reinforcing bar is observed in the MH (manhole) upper floor slab. The left diagram of FIG. 8 is a cross-sectional view of a portion where corrosion of a reinforcing bar is observed in an MH (manhole) upper floor slab. Rust is observed in an exposed streak portion, but a corrosion range under concrete is unknown. There is a concern of the reinforcing bar under the concrete corroding in the vicinity of the exposed streak portion, but since the range thereof cannot be visually checked, a region requiring repair such as rust removal is unknown. Therefore, as illustrated in the right diagram of FIG. 8, the region requiring the repair such as rust removal is performed by visually checking the presence or absence of corrosion of the reinforcing bar in the concrete chipping process. When the reinforcing bar is exposed, cross-section repair is performed, and repair such as removal of deteriorated concrete, rust removal, and backfilling with mortar is performed.

Non Patent literature 1 discloses a standard for repairing an existing concrete structure for the purpose of restoring or improving durability of a concrete structure in the field of civil engineering.

### CITATION LIST

### Non Patent Literature

Non Patent Literature 1: Hiroshi Katahira and three others, “konkurito kouzoubutsu no hoshuu taisaku sikou manual (an) (in Japanese) (Manual of Construction of Concrete Structure Repair Measures (Propsed)”, Public Works Research Institute Material, No. 4343, published in August 2016

### Summary of Invention

### Technical Problem

However, in corrosion determination by visual check, there is a probability that a corrosion region where no clear rust is generated will be overlooked. FIG. 9 is a diagram for describing macrocell corrosion at a boundary between a repaired portion and an unrepaired portion. When the corroded region is overlooked, as illustrated in Fin 9, there is a concern that corrosion will progress in the unrepaired portion. In particular, there is a concern that macrocell corrosion will progress at an accelerated rate at the boundary between the repaired portion and the unrepaired portion. Note that, in FIG. 9, e⁻ is excess electrons generated in a metal base material by elution of metal (iron), and is consumed by oxygen reduction or the like.

An object of the present invention made in view or such circumstances is to provide a peeling device, a peeling method, and a program or forcibly peeling concrete in a region in which there is a concern that corrosion of a structure in which a reinforcing bar is embedded will progress by electrochemical control and for specifying a part requiring repair.

### Solution to Problem

In order to solve the above problem, a peeling device according to the present embodiment is a peeling device that assists with repair of a concrete structure in which a reinforcing oar is embedded. The peeling device includes an electrolyte sheet stunk to a concrete surface, a first electrode connected to the electrolyte sheet, a second electrode connected to the exposed reinforcing bar, a potential control unit that applies a voltage to the second electrode by using the first electrode as a reference electrode and performs potential control such that a potential generated in the second electrode falls within a predetermined range, and a current measurement unit that continuously measures a current value of a current flowing from the second electrode to the first electrode.

In order to solve the above problems, a peeling method according to the present embodiment is a peeling method of assisting with repair of a concrete structure in which a reinforcing bar is embedded. The peeling method includes, by a peeling device, a step of applying a voltage to a second electrode by using a first electrode as a reference electrode and performing potential control such that a potential generated in the second electrode falls within a predetermined range, a step of continuously measuring a current value of a current flowing from the second electrode to the first electrode, and a step of determining peeling check of concrete by determining whether or not the measured current value falls within a determination reference section from a first threshold value to a second threshold value.

In order to solve the above problems, a program according to the present embodiment causes a computer to function as the above peeling device.

### Advantageous Effects of Invention

According to the present disclosure, it is possible to suppress an occurrence of re-repair in the vicinity of a repaired portion by forcibly peeling concrete in a region in which there is a concern that corrosion will progress by electrochemical control to expose a repaired part.

### BRIEF DESCRIPTION OF DRAWINGS

FIG. 1 is a diagram illustrating a configuration example of a peeling device according to a first embodiment.

FIG. 2 is a diagram for describing an operation of the peeling device according to the first embodiment.

FIG. 3 is a diagram in which a corrosion acceleration range of a reinforcing bar is drawn in a potential-pH diagram of Fe.

FIG. 4 is a flowchart illustrating an example of a peeling method performed by the peeling device according to the first embodiment.

FIG. 5 is a diagram illustrating a configuration example of a peeling device according to a second embodiment.

FIG. 6 is a flowchart illustrating an example of a peeling method performed by the peeling device according to the second embodiment.

FIG. 7 is a block diagram illustrating a schematic configuration of a computer functioning as the peeling device.

FIG. 8 is a view for describing a region in which an exposed streak portion is deteriorated, and repair is needed in the related art.

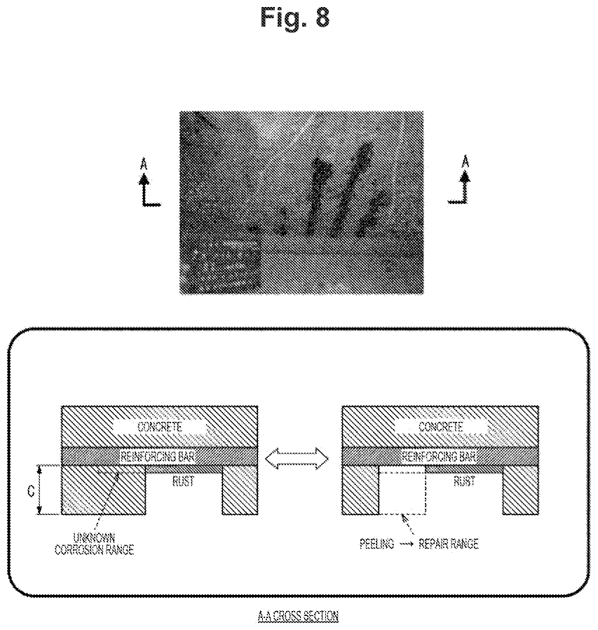

FIG. 9 is a diagram for describing macrocell corrosion at a boundary between a repaired portion and an unrepaired portion.

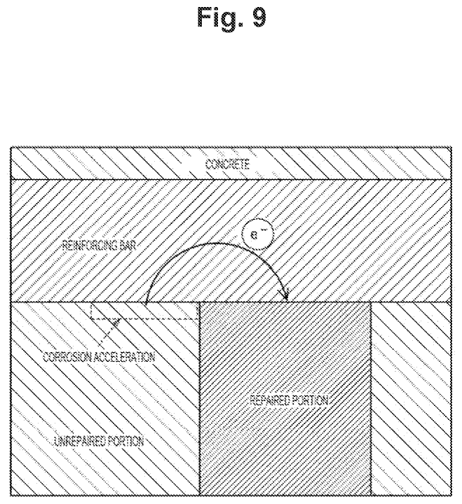

### DESCRIPTION OF EMBODIMENTS

Hereinafter, modes for carrying out the present invention will be described in detail with reference to the drawings. The present invention is not limited to the embodiments described below, and various modifications can be made within the scope of the gist of the present invention.

### First Embodiment

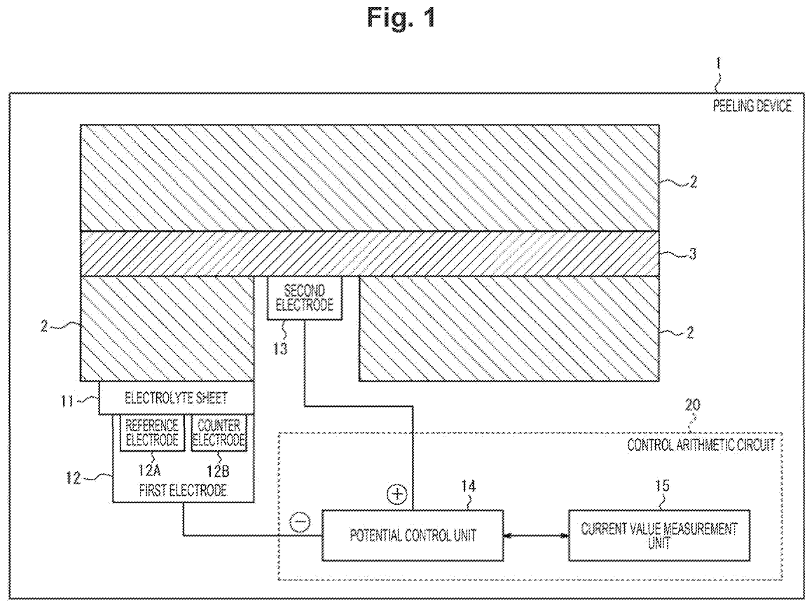

FIG. 1 is a diagram illustrating a configuration example of a peeling device 1 according to a first embodiment. As illustrated in FIG. 1, the peeling device 1 includes an electrolyte sheet 11, a first electrode 12, a second electrode 13, a potential control unit 14, and a current measurement unit 15. The peeling device 1 assists with repair of a concrete structure in which a reinforcing bar 3 is embedded.

The potential control unit 14 and the current measurement unit 15 constitute a control arithmetic circuit (controller) 20. The control arithmetic circuit 20 may be configured by dedicated hardware such as an application specific integrated circuit (ASIC) or a field-programmable gate array (FPGA), may be configured by a processor, or may be configured to include both the hardware and the processor.

The electrolyte sheet 11 is stuck to the surface of concrete 2 and accelerates corrosion of the concrete 2 due to voltage application. The electrolyte sheet 11 is obtained by gelling an aqueous solution containing an electrolyte with a gelling agent such as agar. Planar voltage control is enabled in the electrolyte sheet 11 by mixing an electrolyte such as copper sulfate or potassium chloride. The electrolyte sheet 1 is connected to a reference electrode 12A and a counter electrode 12B constituting the first electrode 12 to be described later. Moisture and an electrolyte dissolved in the moisture are required for electrical connection, and thus it is not possible to retain the electrolyte-containing aqueous solution itself on the surface of the concrete 2. By gelling the electrolyte-containing aqueous solution, it is possible to retain the electrolyte-containing aqueous solution on the surface of the concrete 2. In this sense, the electrolyte sheet 11 may be formed by a sponge or the like containing an aqueous solution containing the electrolyte.

The first electrode 12 is connected to the electrolyte sheet 11. As illustrated in FIG. 1, the first electrode 12 includes a reference electrode 12A and a counter electrode 12B. The second electrode 13 to be described later is a working electrode. The reference electrode 12A is an electrode that provides a reference point of the potential at the time of measuring the electrode potential. The working electrode 13 is an electrode used to obtain an electric signal such as a current and a potential related to an electrode reaction of a target substance. The counter electrode 12B is an electrode that forms a pair of electrodes with the working electrode 13. The potential control unit 14 (also referred to as a potentiostat 14 below) to be described later applies a voltage to the second electrode 13 (working electrode 13) by using the reference electrode 12A of the first electrode 12 as a reference electrode. Since the input impedance of the potentiostat 11 on the reference electrode 12A side is set high, a current flows between the working electrode 13 and the counter electrode 12B, and the reference electrode 12A retains a stable potential.

The reference electrode 12A uses copper as an electrode material when copper sulfate is used as the electrolyte, and uses silver as the electrode material when potassium chloride is used as the electrolyte. When potassium chloride is used as the electrolyte, the reference electrode 12A can be caused to act as a silver-silver chloride electrode by using silver for the electrode.

The second electrode 13 is connected onto the exposed reinforcing bar 3. The second electrode 13 functions as the working electrode 13. The second electrode 13 is attached onto the exposed reinforcing bar 3 via a sponge containing moisture or conductive tape. By attaching the second electrode 13 via the sponge or the conductive tape, planar conduction can be ensured.

The potential control unit 14 applies a voltage to the second electrode 13 by using the reference electrode 12A of the first electrode 12 connected to the electrolyte sheet 11 as the reference electrode, and performs potential control such that the potential generated in the second electrode 13 falls within a predetermined range. Regarding the potential within the predetermined range, the range of the potential generated in the second electrode 13 is within a range of −0.5 V to +0.35 V vs. SHE in which corrosion does not process in a concrete un-neutralized region and corrosion progresses only in a neutralized region. The “vs. SHE” means a potential using a hydrogen electrode (0 V) as a reference.

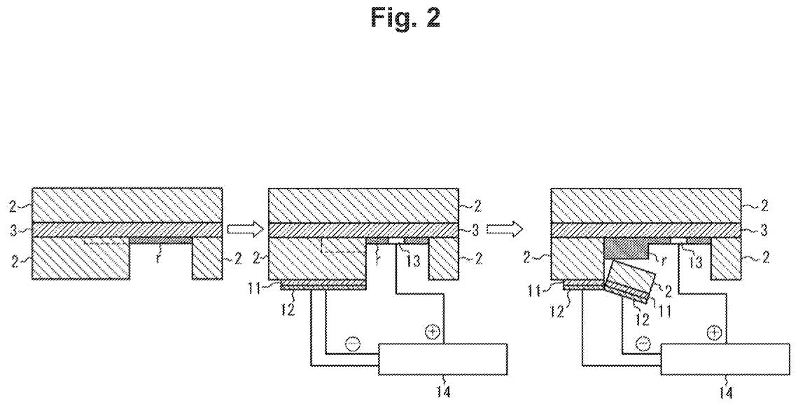

FIG. 2 is a diagram for describing the operation of the peeling device according to the first embodiment. By applying a voltage to the exposed reinforcing bar, the potential control unit 14 accelerates corrosion of a reinforcing bar portion where there is a concern of corroding under the concrete 2, forcibly peels the concrete 2, and makes a repair target region clear from the peeled portion. As illustrated in FIG. 2, the potential control unit 14 applies a voltage between the first electrode 12 attached onto the electrolyte sheet 11 and the second electrode 13 attached onto the exposed reinforcing bar 3 having rust r (al so referred to as a corrosion product r), thereby increasing a corrosion rate in a region having a probability of the reinforcing bar 3 corroding under the concrete 2. As a result, the concrete 2 can be forcibly peeled off due to the volume expansion of the corrosion product r, and thus it is possible to replace the peeling work. The reinforcing bar 3 in the region where the concrete 2 is peeled off is subjected to Kellen-Mortar backfilling to suppress re-deterioration in the vicinity of the repaired portion.

In a normal state of the concrete 2, the components of cement produce a large amount of calcium hydroxide by hydration and the concrete is strongly alkaline at pH 12 to 13. When carbon dioxide in the air comes into contact with the surface of the concrete 2, a chemical reaction occurs with the calcium hydroxide, and thus “neutralization” in which calcium hydroxide changes to neutral calcium carbonate and water, and the concrete 2 loses alkalinity occurs. In a state where the concrete 2 is alkaline, a passive film which is a thin oxide film is formed on the reinforcing bar 3 and plays a role of rust prevention. However, when neutralization progresses and the concrete 2 in which the alkalinity is lost corrodes to the reinforcing bar portion, rust r is generated in the reinforcing bar 3, leading to cracking of the concrete 2 due, to expansion caused by the rust r.

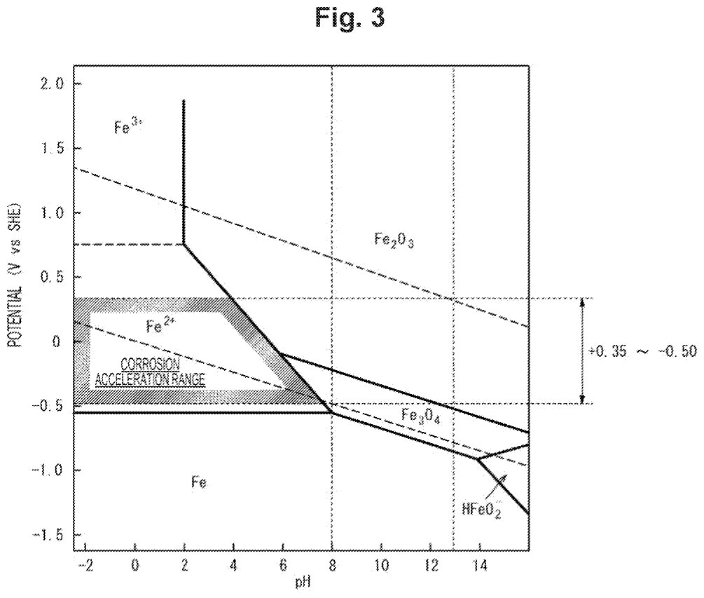

FIG. 3 is a diagram in which a corrosion acceleration range of the reinforcing bar is drawn in a potential-pH diagram of Fe, which is inserted in Chapter 11 (2017) of “Handbook of Thermal Spraying Engineering”, Japan Society of Thermal Spraying. According to FIG. 3, it can be seen that corrosion of the reinforcing bar 3 is accelerated when a voltage within a range of −0.5 V to +0.35 V vs. SHE is applied in a neutralized region where neutralization of the concrete 2 has progressed (a region where pH is 8 or less in FIG. 3). On the other hand, corrosion does: not progress in an un-neutralized region under alkaline conditions (a region with a pH higher than 8 in FIG. 3).

The current measurement unit 15 continuously measures the current value of the current flowing from the second electrode 13 to the counter electrode 12B of the first electrode 12. When the potential control unit 14 starts potential control, the current measurement unit 15 measures the current value and outputs the current value to the potential control unit 14. Since the current value sharply increases or decreases immediately after the start of the potential control due to an influence of a non-Faraday current, about 10 minutes after the start of the potential control is set as the standby time. The current value only needs to be acquired at any time interval, but is desirably acquired at an interval of 1 second to 60 seconds. After the standby time has elapsed, the current measurement unit 15 continuously measures the current value and outputs the measured value to the potential control unit 14.

The potential control unit 14 determines peeling check of the concrete 2 by determining whether or not the current value measured by the current measurement unit 15 falls within a determination reference section from a first threshold value corresponding to a lower limit threshold value to a second threshold value corresponding to an upper limit threshold value. The potential control unit 14 continuously performs the current measurement if the current value is within the determination reference section, and ends the potential control if the current value deviates from the determination reference section. The potential control unit 14 acquires a change of the current value received from the current measurement unit 15 over time. When corrosion of the reinforcing bar is accelerated and cracking or peeling occurs in the concrete 2, the electrolyte sheet 11 attached to the concrete surface is also partially broken, so that a discontinuous point of the current value is generated. Therefore, in the process of acquiring the change over time, the potential control unit 14 regards a time point at which the current value deviates from the determination reference section from the first threshold value to the second threshold value as a time point at which the concrete 2 is peeled off, and ends the potential control. The current value deviating from the determination reference section from the first threshold value to the second threshold value as also referred to as an abnormal value below.

For detection of the abnormal value, an outlier from an approximate curve obtained in continuous measurement of the current may be detected. The approximate curve creation period may be freely set, but Is desirably set to a period of 10 minutes or longer in the past from the time of the latest measurement. The approximate curve value is derived by any method such as a least squares method, a maximum likelihood method, or a K neighborhood method. When the measured value deviates from an error in the approximate period or more, or when the variation in the measured value deviates from any significance level, it is determined that the measured value deviates from the determination reference section from the first threshold value corresponding to the lower limit threshold value to the second threshold value corresponding to the upper limit threshold value. The least squares method is a method of minimizing the sum of squares of errors in processing of measurement values with the errors and obtaining the most probable relational expression. The maximum likelihood method is a method of estimating a population parameter of a probability distribution that maximizes a probability of obtaining the maximum likelihood method from a given observation value (sample) in mathematical statistics. The K neighborhood method is a classification method based on the closest training example in a feature space, and is often used in pattern recognition.

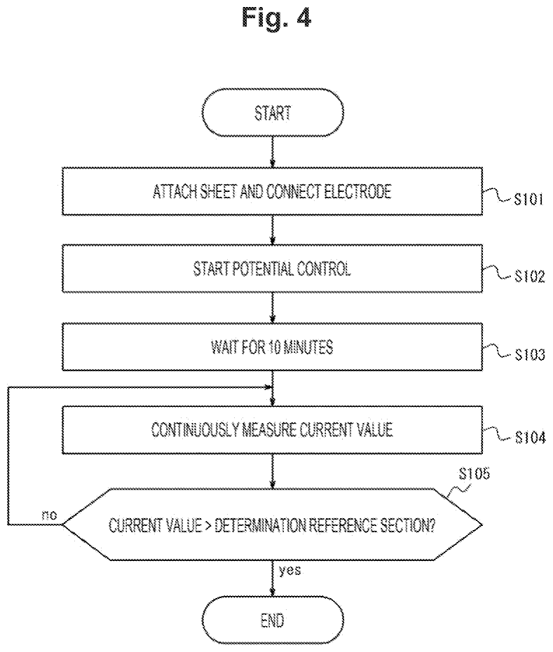

FIG. 4 is a flowchart illustrating an example of the peeling method performed by the peeling device 1 according to the first embodiment.

In Step S101, a worker sticks the electrolyte sheet 11 to the surface of the concrete 2, connects the first electrode 12 to the electrolyte sheet 11, and connects: the second electrode 13 to the exposed reinforcing bar 3.

In Step S102, the potential control unit 14 starts the potential control. Specifically, the potential control unit 14 applies a voltage to the second electrode 13 by using the reference electrode 12A of the first electrode 12 as the reference electrode, and performs potential control such that the potential generated in the second electrode 13 falls within a predetermined range.

In Step S103, the current measurement unit 15 waits for 10 minutes after the start of the potential control without starting the measurement of the current value. This is because the current value rapidly increases or decreases immediately after the start of the potential control due to the influence of the non-Faraday current.

In Step S104, the current measurement unit 15 continuously measures the current value of the current flowing from the second electrode 13 to the first electrode 12.

In Step S105, the potential control unit 14 determines peeling check of the concrete 2 by determining whether or not the current value measured by the current measurement unit 15 falls within the determination reference section from the first threshold value to the second threshold value. The process returns to Step 3104 if the current value is within the determination reference section, and the potential control is ended if the current value deviates from the determination reference section.

According to the peeling device 1 according to the present embodiment, it is possible to suppress the occurrence of re-repair in the vicinity of the repaired portion by forcibly peeling the concrete 2 in the region in which there is a concern that corrosion will progress by electrochemical control to expose the repaired part. In addition, according to the peeling device 1, by using the reference electrode 12A as the reference and setting the potential generated in the second electrode 13 within the limited range of −0.5 V to +0.35 V vs. SHE, it is possible to suppress the progress of corrosion of the reinforcing bar that remains passivated under alkaline conditions, which is a region that does not require repair.

### Second Embodiment

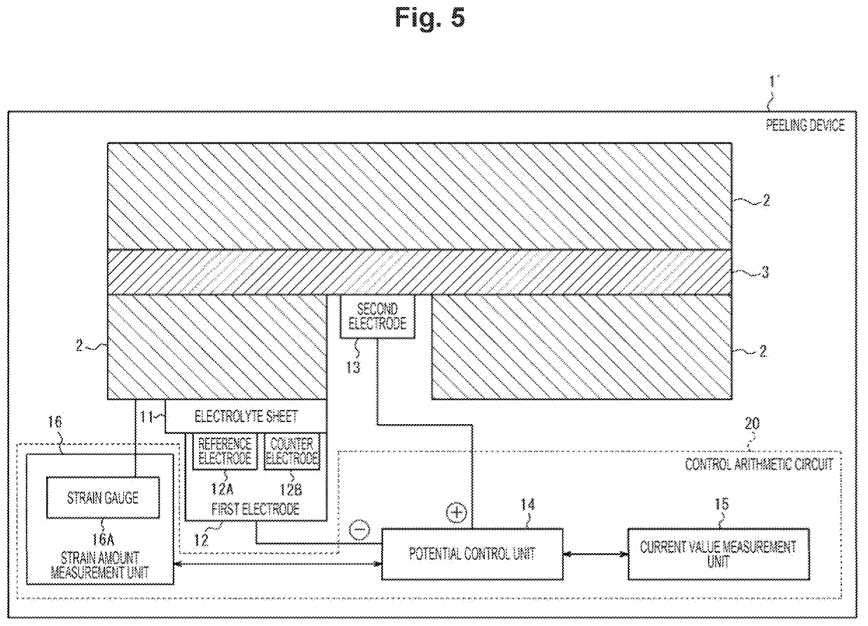

FIG. 5 is a diagram illustrating a configuration example of a peeling device 1′ according to a second embodiment. As illustrated in FIG. 5, the peeling device 1′ includes an electrolyte sheet 11, a first electrode 12, a second electrode 13, a potential control unit 14′, a current measurement unit 15, and a strain amount measurement unit 16. The peeling device 1′ according to the present embodiment is different from the peeling device 1 according to the first embodiment in that the function of the potential control unit 14′ is partially expanded and that the strain amount measurement unit 16 is further provided. The same components as those of the first embodiment will be denoted by the same reference signs as those of the first embodiment, and the description thereof will be omitted as appropriate.

The potential control unit 14′, the current measurement unit 15, and the strain amount measurement unit 16 constitute a control arithmetic circuit (controller) 20′. The control arithmetic circuit 20′ may be configured as dedicated hardware such as an application specific integrated circuit (ASIC) or a field-programmable gate array (FPGA), may be configured as a processor, or may be configured to include both.

The strain amount measurement unit 16 includes a strain gauge 16A. The strain amount measurement unit 16 continuously measures a strain amount generated inside the concrete by the strain gauge 16A installed near the electrolyte sheet 11, and outputs the measured value to the potential control unit 14′.

The potential control unit 14′ determines whether or not the strain amount received by the strain amount measurement unit 16 falls within a third threshold value, continues the strain amount measurement if the strain amount falls within the third threshold value, and ends the potential control if the strain amount exceeds the third threshold value.

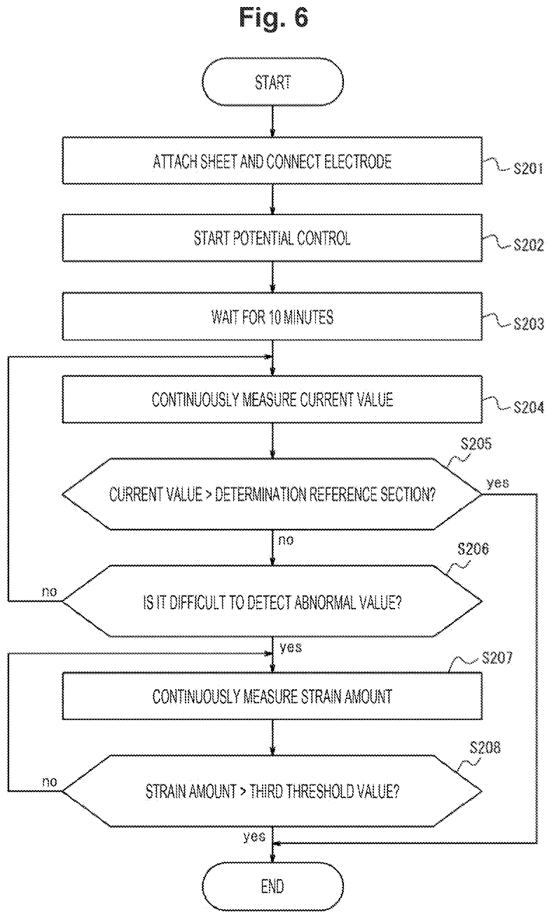

FIG. 6 is a flowchart illustrating an example of a peeling method performed by the peeling device 1′ according to the second embodiment.

In Step S201, a worker sticks the electrolyte sheet 11 to the surface of the concrete, connects the first electrode 12 to the electrolyte sheet 11, and connects the second electrode 13 to the exposed reinforcing bar.

In Step S202, the potential control unit. 14′ starts the potential control. Specifically, the potential control unit 14′ applies a voltage to the second electrode 13 by using the reference electrode 12A of the first electrode 12 as the reference electrode, and performs potential control such that the potential generated in the second electrode falls within a predetermined range.

In Step S203, the current measurement unit 15 waits for 10 minutes after the start of the potential control without starting the measurement of the current value. This is because the current value rapidly increases or decreases immediately after the start of the potential control due to the influence of the non-Faraday current.

In Step S204, the current measurement unit 15 continuously measures the current value of the current flowing from the second electrode 13 to the first electrode 12.

In Step S205, the potential control unit 14′ determines peeling check of the concrete 2 by determining whether or not the current value measured by the current measurement unit 15 falls within the determination reference section from the first threshold value to the second threshold value. The process proceeds to Step S206 if the current value is within the determination reference section, and the potential control is ended if the current value deviates from the determination reference section.

In Step S206, the potential control unit 14′ determines whether or not it is difficult to detect an abnormal value. The process returns to Step S204 if it is determined that it is not difficult to detect the abnormal value, and the process proceeds to Step S207 if it is determined that it is difficult to detect the abnormal value.

In Step S207, the strain amount measurement unit 16 continuously measures the strain amount generated inside the concrete 2.

In Step S203, the potential control unit 14′ determines whether or not the strain amount falls within the third threshold value, causes the process to return to Step S207 if the strain amount falls within the third threshold value, and ends the potential control if the strain amount exceeds the third threshold value.

According to the peeling device 1′ according to the present embodiment, even when it is assumed that it is difficult to detect an abnormal value (current value deviating from the determination reference section from the first threshold value to the second threshold value), it is possible to perform peeling check of the concrete 2 by measuring the strain amount.

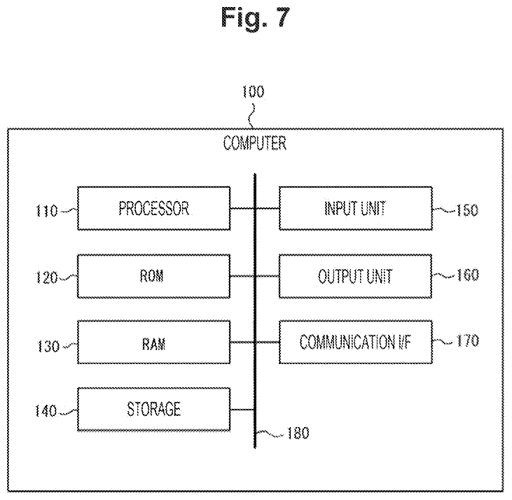

In order to cause the peeling devices 1 and 1′ to function, it is also possible to use a computer capable of executing a program instruction. FIG. 7 is a block diagram illustrating a schematic configuration of a computer functioning as the peeling devices 1 and 1′. Here, the computer that functions as the peeling devices 1 and 1′ may be a general-purpose computer, a dedicated computer, a workstation, a personal computer (PC), an electronic note pad, or the like. The program instruction may be a program code, a code segment, or the like, for executing a necessary task.

As illustrated in FIG. 7, a computer 100 includes a processor 110, a read only memory (ROM) 1120, a random access memory (RAM) 130, and a storage 140 as storage units, an input unit 150, an output unit 160, and a communication interface (I/F) 170. The components are communicably connected to each other via a bus 180.

The ROM 120 stores various kinds of programs and various kinds of data. The RAM 130 temporarily stores a program or data as a working area. The storage 140 is constituted by a hard disk drive (HDD) or a solid state drive (SSD) and stores various kinds of programs including an operating system and various kinds of data. In the present disclosure, the program according to the present disclosure is stored in the ROM 120 or the storage 140.

Specifically, the processor 110 is a central processing unit (CPU), a micro processing unit (MPU), a graphics processing unit (GPU), a digital signal processor (DSP), a system on a chip (SoC), or the like, and may be constituted by the same or different types of plurality of processors. The processor 110 reads a program from the ROM 120 or the storage 140 and executes the program by using the PAM 130 as a working area to perform control of each of the above-described components and various kinds or arithmetic processing. Note that at least part of these processing content may be implemented by hardware.

The program may be recorded in a recording medium readable by the peeling devices 1 and 1′. By using such a recording medium, the recording medium can be installed in the peeling devices 1 and 1′. Here, the recording medium on which the program is recorded may be a non-transitory recording medium. The non-transitory recording medium is not particularly limited, but may be, for example, a CD-ROM, a DVD-ROM, a Universal Serial Bus (USB) memory, or the like. Furthermore, the program may be downloaded from an external device via a, network.

Regarding the above embodiments, the following supplementary notes are further disclosed.

### Supplement 1

A peeling device that assists with repair of a concrete structure in which a reinforcing bar is embedded, the peeling device including:
an electrolyte sheet stuck to a concrete surface;
a first electrode connected to the electrolyte sheet;
a second electrode connected to the exposed reinforcing bar; and
a controller that applies a voltage to the second electrode by using the first electrode as a reference electrode and performs potential control such that a potential generated in the second electrode falls within a predetermined range, and continuously measures a current value of a current flowing from the second electrode to the first electrode.

### Supplement 2

The peeling device according to Supplement 1, in which
regarding the potential within the predetermined range, a range of the potential generated in the second electrode is −0.5 V to +0.35 vs. SHE.

### Supplement 3

The peeling device according to Supplement 1 or 2, in which
the electrolyte sheet is obtained by gelling an aqueous solution containing an electrolyte with a gelling agent.

### Supplement 4

The peeling device according to Supplement 3 in which
the electrolyte is copper sulfate or potassium chloride, and
the reference electrode of the first electrode uses copper as an electrode material when the electrolyte is copper sulfate, and uses silver as the electrode material when the electrolyte is potassium chloride.

### Supplement 5

The peeling device according to any one of Supplements 1 to 4, in which
the controller
determines peeling check of the concrete based on whether or not the current value measured by the current measurement unit falls within a determination reference section from a first threshold value to a second threshold value,
continues the current measurement if the current value falls within the determination reference section, and ends the potential control if the current value deviates from the determination reference section.

### Supplement 6

The peeling device according to any one of Supplements 1 to 5, in which
the controller
continuously measures a strain amount generated inside the concrete by a strain gauge installed near the electrolyte sheet,
determines whether or not the strain amount falls within a third threshold value,
continues the strain amount measurement if the strain amount falls within the third threshold value, and
ends the potential control if the strain amount exceeds the third threshold value.

### Supplement 7

A peeling method of assisting with repair of a concrete structure in which a reinforcing bar is embedded, the peeling method including
by a peeling device,
applying a voltage to a second electrode by using a first electrode as a reference electrode and performing potential control such that a potential generated in the second electrode falls within a predetermined range;
continuously measuring a current value of a current flowing from the second electrode to the first electrode; and
determining peeling check of concrete by determining whether or not the measured current value falls within a determination reference section from a first threshold value to a second threshold value.

### Supplement 8

A non-transitory storage medium storing a program that is executable by a computer, the program causing the computer to function as the peeling device according to any one of Supplements 1 to 6.

Although the above-described embodiment has been described as a representative example, it is apparent to those skilled in the art that many changes and substitutions can be made within the spirit and scope of the present disclosure. Accordingly, it should not be understood that the present invention is limited by the above-described embodiment, and various modifications or changes can be made without departing from the scope of the claims. For example, a plurality of configuration blocks described in a configuration diagram of the embodiment can be combined into one, or one configuration block can be divided.

### REFERENCE SIGNS LIST

1,1′ Peeing device
2 Concrete
3 Reinforcing bar
11 Electrolyte sheet
12 First electrode
12A Reference electrode
12B Counter electrode
13 Second electrode (working electrode)
14 Potential control unit (potentiostat)
15 Current value measurement unit
16 Strain amount measurement unit
16A Strain gauge
20, 20′ Control arithmetic circuit (controller)
100 Computer
110 Processor
120 ROM
130 RAM
140 Storage
150 Input unit
160 Output unit
170 Communication interface (I/F)
180 Bus

1. A peeling device that assists with repair of a concrete structure in which a reinforcing bar is embedded, the peeling device comprising:
an electrolyte sheet stuck to a concrete surface;
a first electrode connected to the electrolyte sheet;
a second electrode connected to the exposed reinforcing bar;
a potential control unit that applies a voltage to the second electrode by using the first electrode as a reference electrode and performs potential control such that a potential generated in the second electrode falls within a predetermined range; and
a current measurement unit that continuously measures a current value of a current flowing from the second electrode to the first electrode.

2. The peeling device according to claim 1, wherein
regarding the potential within the predetermined range, a range of the potential generated in the second electrode is −0.5 V to +0.35 V vs. SHE.

3. The peeling device according to claim 1, wherein
the electrolyte sheet is obtained by gelling an aqueous solution containing an electrolyte with a gelling agent.

4. The peeling device according to claim 3, wherein
the electrolyte is copper sulfate or potassium chloride, and
the reference electrode of the first electrode uses copper as an electrode material when the electrolyte is copper sulfate, and uses silver as the electrode material when the electrolyte is potassium chloride.

5. The peeling device according to claim 1, wherein
the potential control unit
determines peeling check of the concrete based on whether or not the current value measured by the current measurement unit falls within a determination reference section from a first threshold value to a second threshold value,
continues the current measurement if the current value falls within the determination reference section, and
ends the potential control if the current value deviates from the determination reference section.

6. The peeling device according to claim 1, further comprising:
a strain amount measurement unit that continuously measures a strain amount generated inside the concrete by a strain gauge installed near the electrolyte sheet,
wherein the potential control unit
further determines whether or not the strain amount falls within a third threshold value,
continues the strain amount measurement if the strain amount falls within the third threshold value, and
ends the potential control if the strain amount exceeds the third threshold value.

7. A peeling method of assisting with repair of a concrete structure in which a reinforcing bar is embedded, the peeling method comprising:
by a peeling device,
applying a voltage to a second electrode by using a first electrode as a reference electrode and performing potential control such that a potential generated in the second electrode falls within a predetermined range;
continuously measuring a current value of a current flowing from the second electrode to the first electrode; and
determining peeling check of concrete by determining whether or not the measured current value falls within a determination reference section from a first threshold value to a second threshold value.

8. (canceled)

9. A computer-readable non-transitory recording medium storing computer-executable program instructions that when executed by a processor cause a computer to execute a peeling method comprising:
by a peeling device,
applying a voltage to a second electrode by using a first electrode as a reference electrode and performing potential control such that a potential generated in the second electrode falls within a predetermined range;
continuously measuring a current value of a current flowing from the second electrode to the first electrode; and
determining peeling check of concrete by determining whether or not the measured current value falls within a determination reference section from a first threshold value to a second threshold value.
